(19) United States
(12) Patent Application Publication
(10) Pub. No.: US 2017/0127815 A1
(43) Pub. Date: May 11, 2017

(54) Hairbrush with Fiber Optic Lights

(71) Applicant: Bundy Renfro, Lago Vista, TX (US)

(72) Inventor: Bundy Renfro, Lago Vista, TX (US)

(21) Appl. No.: 14/934,598

(22) Filed: Nov. 6, 2015

(51) Int. Cl. A46B 9/02; A46B 15/00; B25G 1/00; A46B 9/06; A46B 17/08; A46B 5/00

(52) U.S. Cl. CPC A46B 9/023; A46B 17/08; A46B 5/00; A46B 9/028; B25G 1/00; A46B 9/06; A46B 15/0087; A46B 2200/104

(57) ABSTRACT

A hairbrush having illuminating elements includes a brush portion and a handle portion, with a brush panel supported in an aperture of the brush portion. The brush panel has an interior side facing a hollow interior region of the hairbrush and an exterior side facing away from the interior region of the hairbrush. A fiber-optic bundle comprising a plurality of fiber-optic fibers extends from a bound end thereof, through the brush panel, and from the exterior side of the brush panel. Portions of the fiber-optic fibers extending from the exterior side of the brush panel serve as fiber-optic bristles. A light-emitting element is disposed within the hairbrush. The light-emitting element is configured for emitting light when activated. Circuitry is provided for activating the light-emitting element to emit light that is received by the bound end of the fiber-optic bundle and emitted by the fiber-optic bristles.

### BACKGROUND

### Field of the Invention

The present application relates generally to hairbrushes, and more specifically, to hairbrushes having illuminating elements.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a bottom perspective view of a hairbrush according to the present disclosure;

FIG. 2 is an enlarged view of region 2 shown in FIG. 1;

FIG. 3 is a top perspective view of the hairbrush shown in FIG. 1;

FIG. 4 is an exploded view of the hairbrush shown in FIG. 1;

FIG. 5 is a top perspective view of the hairbrush shown in FIG. 1 with the upper shell removed therefrom;

FIG. 6 is an enlarged bottom view of an embodiment of a handle of the hairbrush shown in FIG. 1; and

FIG. 7 is a schematic view of an embodiment of an electrical circuit of the hairbrush shown in FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the apparatus and method are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

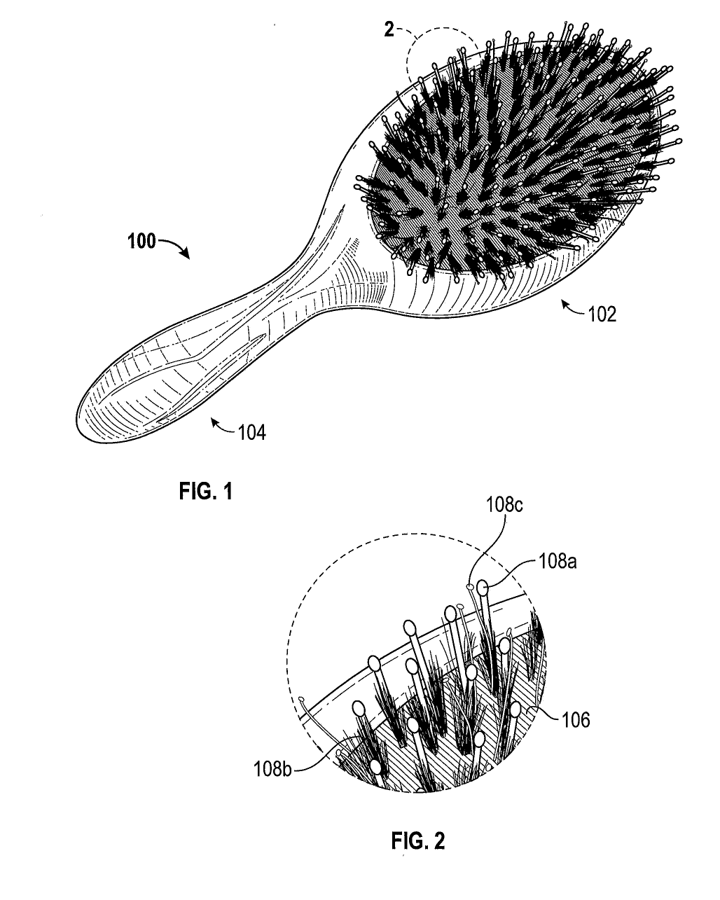

Referring to FIG. 1, a bottom perspective view is provided of a hairbrush 100 according to the present application. The hairbrush 100 includes a brush portion 102 and a handle portion 104.

FIG. 2 shows an enlarged view of region 2 shown in FIG. 1. The brush portion 102 includes a perforated brush panel 106. The brush panel 106 can be formed of a rigid material, such as plastic, or can be formed of a flexible material, such as rubber. A plurality of bristles 108 extend through the brush panel 106. More specifically, the bristles can include beaded-tip bristles 108a, tufted bristles 108b, and/or fiber-optic bristles 108c. As described in greater detail below, light is emitted by the fiber-optic bristles 108c. However, the beaded-tip bristles 108a and the tufted bristles 108b, which are non-fiber-optic bristles, do not emit light. As described in greater detail below, the fiber-optic bristles 108c extend through the brush panel 106 towards a base end of the fiber-optic bundle, which is located proximate to a light-emitting element. On the other hand, the non-fiber-optic bristles (the beaded-tip bristles 108a and the tufted bristles 108b) are fixed to the brush panel 106. The non-fiber-optic bristles 108a, 108b can be formed of plastic, nylon, metal, boar hair, or other known types of hairbrush bristle materials.

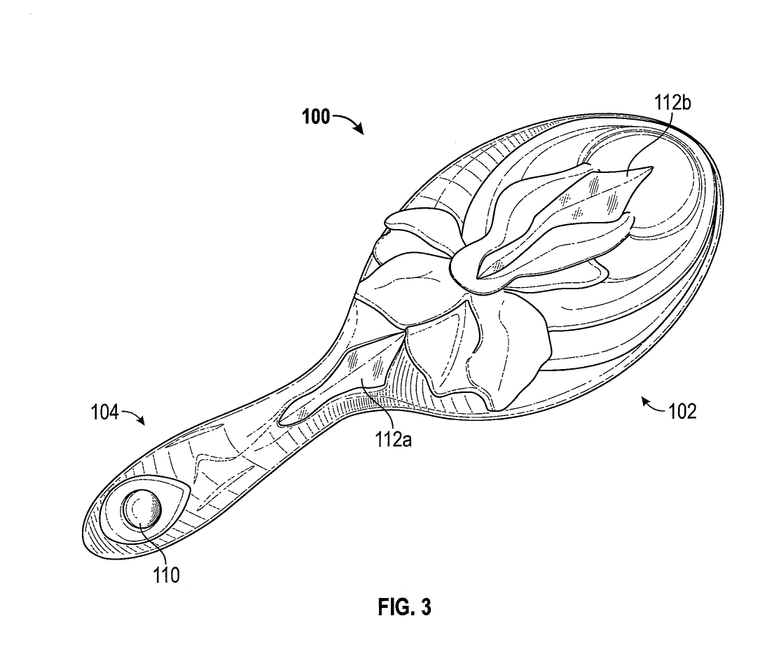

FIG. 3 shows a top perspective view of the hairbrush 100. The handle portion 104 includes a push-button switch 110. Also, the hairbrush 100 includes a plurality of translucent lenses 112. In the illustrated embodiment, the brush portion 102 and the handle portion 104 include first and second lenses 112a, 112b. The push-button switch 110 can be pressed to activate a light source within the hairbrush 100, as is described in greater detail below. The light source within the hairbrush 100 emits light that can be seen through the lenses 112 and through the fiber-optic bristles 108c.

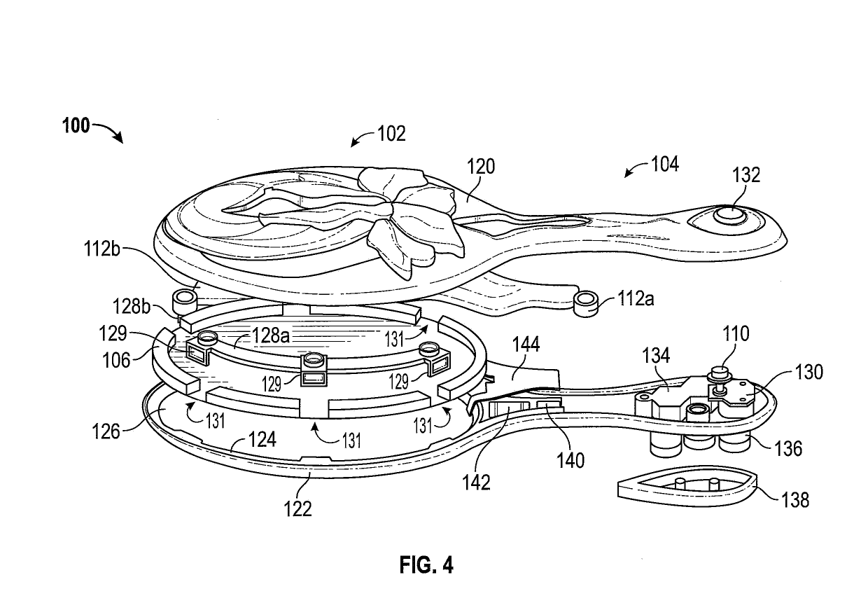

FIG. 4 shows an exploded view of the hairbrush 100. The hairbrush 100 includes an upper shell 120 and a lower shell 122, which can be assembled together to form a housing of the hairbrush 100. The upper shell 120 and the lower shell 122 can be formed of a rigid material, such as plastic, wood, or metal. The upper shell 120 and the lower shell 122 can be assembled to define a hollow interior of the hairbrush 100. The upper shell 120 and the lower shell 122 can be fixed together by any of a variety of attachment means, for example by gluing, screwing, and/or snapping the upper shell 120 and the lower shell 122 together.

The brush panel 106 is supported by the lower shell 122. The lower shell 122 includes a rim portion 124 that defines a brush-panel aperture 126. The brush panel 106 is larger than the brush-panel aperture 126 so that the rim portion 124 can retain the brush panel 106 and the brush panel 106 can extend across the brush-panel aperture 126. The first and second lenses 112a, 112b are supported by the upper shell 120. More specifically, the first and second lenses 112a, 112b are disposed in respective lens apertures in the upper shell 120.

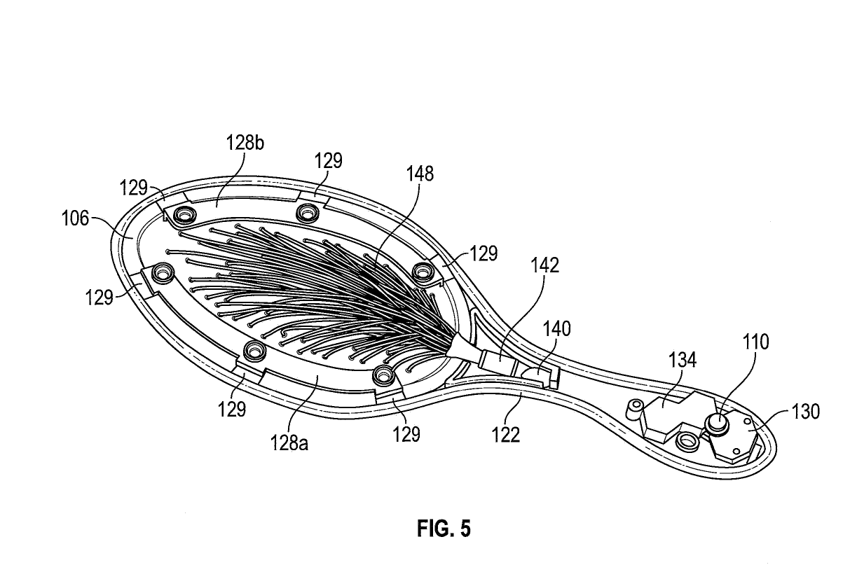

The hairbrush 100 also includes rigid frame members 128a and 128b. The frame members 128a, 128b are secured between the brush panel 106 and the upper shell 120. The frame members 128a, 128b can be secured to the upper shell 120 and to the lower shell 122 using any of a variety of securing means, such as snaps, screws, and/or adhesives. The frame members 128a, 128b urge the brush panel 106 against the lower shell 122 to prevent the brush panel 106 from slipping into the hollow interior of the hairbrush 100. The frame members 128a, 128b each include a plurality of tab members 129, which correspondingly mesh with notches 131 in the brush panel 106 (shown in FIG. 5). The meshing of the tab members 129 and the notches 131 help to secure the brush panel 106 relative to the frame members 128a, 128b, which are in turn secured relative to the upper shell 120 and the lower shell 122.

The handle portion 104 houses the push-button switch 110 and a circuit board 130. The top of the push-button switch 130 is axially aligned with a push-button aperture 132 in the upper shell 120 so that the top of the push-button switch 110 extends through the upper shell 120 at the push-button aperture 132. The base of the push-button switch 110 is attached to the circuit board 130. The circuit board 130 also includes circuitry described below in connection with FIG. 7. The circuit board 130 is supported by a battery compartment 134. The battery compartment 134 is for housing one or more batteries 136. The batteries 136 can be fixed or removable. The handle portion 104 can include a battery compartment cover 138 for removing and replacing the batteries 136 in embodiments where the batteries 136 are removable. The circuit board 130 can include battery-charging circuitry for re-charging the batteries 136 in some embodiments, including embodiments where the batteries 136 are not removable.

The illustrated embodiment of the hairbrush 100 also includes a light-emitting diode (LED) 140 as an implementation of a light source. Any of a variety of types of LEDs can be used depending on implementation goals, such as desired color, color effects, power availability, and desired battery life. For example, some embodiments can include a single LED that is configured to emit a predetermined color of light. Some embodiments can include a plurality of LEDs, each configured to emit a predetermined color of light. Some embodiments can include color-changing LEDs, also sometimes referred to as color-mixing LEDs. For example, some embodiments can include one or more LEDs combined in a common-anode or common-cathode configuration that can be driven together to emit any of a variety of different colors of light.

Light from the LED 140 is directed towards a fiber-optic bundle 142. Only a base portion of the fiber-optic bundle 142 is shown in FIG. 4 for the sake of clarity. A fiber-optic cover 144 is secured between the upper shell 120 and the lower shell 122 to secure the fiber-optic bundle 142 in place. The fiber-optic cover 144 can be formed of plastic that is transparent or at least somewhat translucent so that at least some of the light emitted by the LED 140 can pass therethrough towards the first and second lenses 112a, 112b.

FIG. 5 shows a top perspective view of the hairbrush 100 with the upper shell removed therefrom. The fiber-optic bundle 142 extends from a bound end thereof, which is a base end of the fiber-optic bundle 142 where the fiber-optic fibers 148 thereof are bound together. The base end of the fiber-optic bundle 142 is disposed in close enough proximity to the LED 140 to receive light emitted by the LED 140. The fiber-optic bundle 142 extends towards an interior side of the brush panel 106. The fiber-optic bundle 142 includes a plurality of fiber-optic fibers 148 that fan out from the base of the fiber-optic bundle 142 and pass through the brush panel 106 at numerous locations. The fiber-optic fibers 148 each pass through respective through-holes in the brush panel 106. The portions of each of the fiber-optic fibers 148 that have passed through the brush panel 106 and extend from an exterior side of the brush panel 106 serve as fiber-optic bristles 108c as shown in FIGS. 1 and 2. Thus, light emitted by the LED 140 that is received by the base of the fiber-optic bundle 142 travels through the fiber-optic fibers 148 and is emitted by the fiber-optic bristles 108c.

Also, in addition to serving as light conduits, the fiber-optic fibers 148 can also provide a passive damping or cushioning effect on the brush panel 106 in embodiments that include a brush panel 106 that is formed of a flexible material, such as rubber. The damping or cushioning effect results from the collective mechanical resistance provided by the plurality of fiber-optic fibers 148 against flexing of the brush panel 106 towards the interior region of the hairbrush 100 due to the bends in respective fibers 148 between the base of the fiber-optic bundle 142 and the brush panel 106.

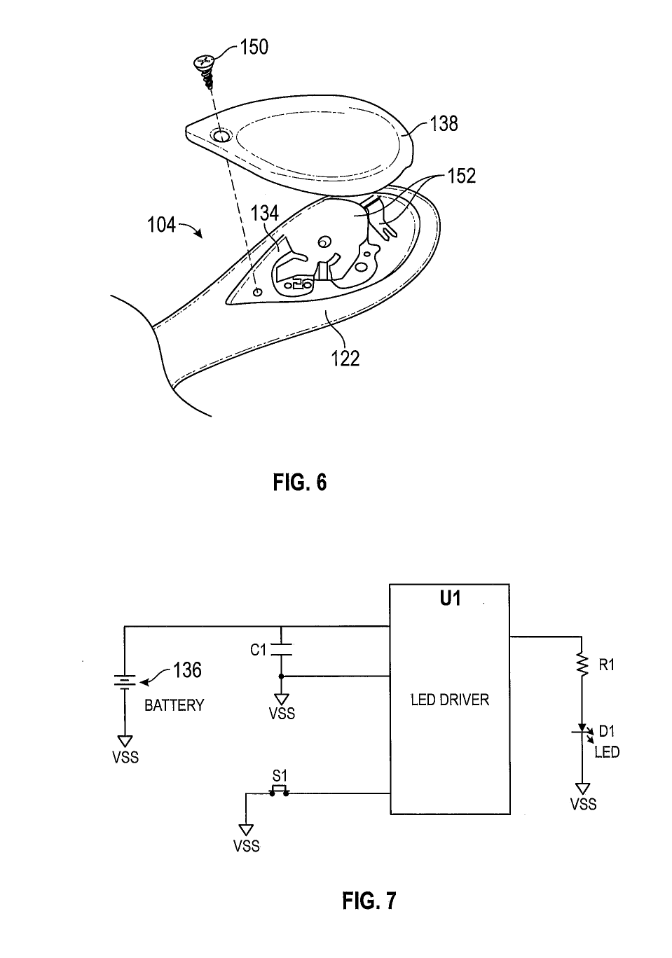

FIG. 6 shows an enlarged bottom view of an embodiment of a handle of the hairbrush 100. The view in FIG. 6 shows the battery compartment cover 138 removed, revealing a view of the battery compartment 134 without the batteries 136 installed. The battery compartment cover 138 can be secured to the lower shell 122 using a screw 150 or other attachment means. The battery compartment 134 includes electrical contacts 152 for providing electrically-conductive pathways between the batteries 136 and the circuitry on the circuit board 130. The illustrated embodiment of the battery compartment 134 includes generally cylindrically-shaped recesses for holding batteries 136 that are button-type batteries. Alternative embodiments can include alternatively-shaped batteries 136 and correspondingly-shaped recesses in the battery compartment 134.

FIG. 7 shows a schematic view of an embodiment of an electrical circuit of the hairbrush 100. There are a great variety of circuit arrangements that can be used in place of the circuit shown in FIG. 7. The circuit shown in FIG. 7 is an LED driver circuit configured to operate the LED 140, which is represented as LED D1 in FIG. 7. The circuit include an LED driver integrated circuit U1. There are many different commercially-available LED driver integrated circuits that can be used as LED driver U1. For example, an integrated circuit can be used as the LED driver U1 that is specifically designed for driving one or more LEDs; alternatively, a more general-purpose integrated circuit, such as a 555 timer, can be used as the LED driver U1.

The remaining circuitry will depend largely on the LED driver integrated circuit that is used in order to provide proper voltage levels and signals as required by the LED driver for proper operation. In the illustrated embodiment, for example, the push-button switch 110 is represented by switch element S1. When the switch is closed, it grounds a pin on the LED driver U1. This causes the LED driver to latch, which begins a cycle where charge is drained from the capacitor C1 and provided to the LED D1, thereby causing the LED D1 to emit light. The resistor R1 is provided to control the level of electrical current that is provided to the LED D1. Once the capacitor C1 has discharged, the LED driver will open the pin to the capacitor C1, allowing the batteries 136 to recharge the capacitor C1. During this part of the cycle the LED D1 is not emitting light. Once the capacitor C1 has recharged, the LED driver U1 provides the voltage from the capacitor C1 to the LED D1, causing the LED D1 to again illuminate. This cycle repeats until the button S1 is pressed again.

The above example provides for a circuit that can drive a flashing LED. Alternative LED drivers can be used to keep the LED illuminated but drive the LED to cycle through various colors, for example using a pulse-width modulation (PWM) driver. Such a circuit can drive a color-changing LED to cycle through colors by providing electrical pulses of varying widths to the LED. Still other alternatives can include circuitry for providing a steadily-lit LED that does not flash or change colors. A simple example of such a circuit can include the battery, the switch, the resistor, and the LED connected in series.

Operation of the hairbrush 100 can vary depending on the circuit that is used. A user can press the push-button switch 110, which causes the LED 140 to begin emitting light. In some embodiments, the user can release the push-button switch 110 and the LED 140 will continue emitting light until the push-button switch 110 is pressed and released again. In alternative embodiments, the LED 140 will continue to emit light only while the push-button switch 110 remains pressed, and will stop emitting light whenever the push-button switch 110 is released or otherwise not pressed.

The particular embodiments disclosed above are illustrative only, as the embodiments may be modified and practiced in different but equivalent manners apparent to those skilled in the art having the benefit of the teachings herein. Thus, the particular embodiments disclosed above may be altered or modified, and all such variations are considered within the scope and spirit of the application. Although the present embodiments are shown above, they are not limited to just these embodiments, but are amenable to various changes and modifications without departing from the spirit thereof.

What is claimed is:

1. A hairbrush comprising:
a brush portion having a rim portion that defines a brush-panel aperture;
a handle portion;
a brush panel supported by the rim portion of the brush portion, the brush panel having an interior side facing an interior region of the hairbrush and an exterior side opposite the interior side, the exterior side facing away from the interior region of the hairbrush, wherein a portion of the brush panel extends across the brush-panel aperture;
a fiber-optic bundle comprising a plurality of fiber-optic fibers, the fiber-optic bundle having a bound end disposed within the interior region of the hairbrush, the plurality of fiber-optic fibers extending from the bound end towards the interior side of the brush panel, at least a portion of each of the plurality of fiber-optic fibers extending through the brush panel and extending from the exterior side of the brush panel, the portions of the fiber-optic fibers extending from the exterior side of the brush panel serving as fiber-optic bristles;
a light-emitting element disposed within the interior region of the hairbrush, the light-emitting element being configured for emitting light when activated; and
circuitry for activating the light-emitting element to emit light and for driving the light-emitting element such that the light emitted by the light-emitting element cycles through a plurality of different colors,
wherein light emitted by the light-emitting element is received by the bound end of the fiber-optic bundle and emitted by the fiber-optic bristles.

2. The hairbrush of claim 1, further comprising a plurality of non-fiber-optic bristles attached to the brush panel and extending from the exterior side of the brush panel.

3. The hairbrush of claim 2, wherein the plurality of non-fiber-optic bristles includes at least one of a beaded-tip bristle and a tufted bristle.

4. The hairbrush of claim 1, further comprising a translucent lens disposed in a lens aperture in the brush portion of the hairbrush.

5. The hairbrush of claim 4, further comprising a fiber-optic cover disposed between the light-emitting element and the translucent lens.

6. The hairbrush of claim 1, wherein the circuitry includes a push-button switch disposed in the handle portion for activating the light-emitting element.

7. The hairbrush of claim 1, wherein the brush panel is formed of a flexible material and wherein the fiber-optic fibers provide mechanical resistance against flexing of the brush panel towards the interior region of the hairbrush.

8. A hairbrush comprising:
a lower shell having a rim portion that defines a brush-panel aperture;
an upper shell attached to the lower shell, the upper and lower shells defining a hollow interior region of the hairbrush;
a brush panel supported by the rim portion of the lower shell, the brush panel having an interior side facing the interior region of the hairbrush and an exterior side opposite the interior side, the exterior side facing away from the interior region of the hairbrush, wherein a portion of the brush panel extends across the brush-panel aperture;
a fiber-optic bundle comprising a plurality of fiber-optic fibers, the fiber-optic bundle having a bound end disposed within the interior region of the hairbrush, the plurality of fiber-optic fibers extending from the bound end towards the interior side of the brush panel, at least a portion of each of the plurality of fiber-optic fibers extending through the brush panel and extending from the exterior side of the brush panel, the portions of the fiber-optic fibers extending from the exterior side of the brush panel serving as fiber-optic bristles;
a light-emitting element disposed within the interior region of the hairbrush, the light-emitting element being configured for emitting light when activated; and
circuitry for activating the light-emitting element to emit light and for driving the light-emitting element such that the light emitted by the light-emitting element cycles through a plurality of different colors,
wherein light emitted by the light-emitting element is received by the bound end of the fiber-optic bundle and emitted by the fiber-optic bristles.

9. The hairbrush of claim 8, further comprising a plurality of non-fiber-optic bristles attached to the brush panel and extending from the exterior side of the brush panel.

10. The hairbrush of claim 9, wherein the plurality of non-fiber-optic bristles includes at least one of a beaded-tip bristle and a tufted bristle.

11. The hairbrush of claim 8, further comprising a translucent lens disposed in a lens aperture in the upper shell.

12. The hairbrush of claim 11, further comprising a fiber-optic cover disposed between the light-emitting element and the translucent lens.

13. The hairbrush of claim 8, wherein the circuitry includes a push-button switch that extends through a push-button aperture in the upper shell for activating the light-emitting element.

14. The hairbrush of claim 8, wherein the brush panel is formed of a flexible material and wherein the fiber-optic fibers provide mechanical resistance against flexing of the brush panel towards the interior region of the hairbrush.

15. A hairbrush comprising:
a housing having a hollow interior region and a rim portion that defines a brush-panel aperture;
a brush panel supported by the rim portion of the housing, the brush panel having an interior side facing an interior region of the hairbrush and an exterior side opposite the interior side, the exterior side facing away from the interior region of the hairbrush, wherein a portion of the brush panel extends across the brush-panel aperture;
a fiber-optic bundle comprising a plurality of fiber-optic fibers, the fiber-optic bundle having a bound end disposed within the interior region of the hairbrush, the plurality of fiber-optic fibers extending from the bound end towards the interior side of the brush panel, at least a portion of each of the plurality of fiber-optic fibers extending through the brush panel and extending from the exterior side of the brush panel, the portions of the fiber-optic fibers extending from the exterior side of the brush panel serving as fiber-optic bristles;
a plurality of non-fiber-optic bristles attached to the brush panel and extending from the exterior side of the brush panel, the plurality of non-fiber-optic bristles including at least one of a beaded-tip bristle and a tufted bristle;
a light-emitting element disposed within the interior region of the hairbrush, the light-emitting element being configured for emitting light when activated; and
circuitry for activating the light-emitting element to emit light,
wherein light emitted by the light-emitting element is received by the bound end of the fiber-optic bundle and emitted by the fiber-optic bristles.

16. The hairbrush of claim 15, further comprising a translucent lens disposed in a lens aperture in the housing.

17. The hairbrush of claim 16, further comprising a fiber-optic cover disposed between the light-emitting element and the translucent lens.

18. The hairbrush of claim 15, wherein the circuitry includes a push-button switch that extends through a push-button aperture in the upper shell for activating the light-emitting element.

19. The hairbrush of claim 15, wherein the brush panel is formed of a flexible material and wherein the fiber-optic fibers provide mechanical resistance against flexing of the brush panel towards the interior region of the hairbrush.

20. The hairbrush of claim 15, further comprising a frame member disposed between the brush panel and an interior side of the housing,
wherein the frame member includes a plurality of tab members, and
wherein the brush panel includes a plurality of notches that mesh with respective tab members of the frame member.
